(19) United States
(12) Patent Application Publication
(10) Pub. No.: US 2018/0131048 A1
(43) Pub. Date: May 10, 2018

(54) THERMOGRAPHY AND THIN FILM BATTERY MANUFACTURING

(71) Applicant: Applied Materials, Inc., Santa Clara, CA (US)

(72) Inventors: Byung-Sung Leo KWAK, Portland, OR (US); Eric NG, Mountain View, CA (US); Lizhong SUN, San Jose, CA (US)

(21) Appl. No.: 15/572,734

(22) PCT Filed: May 11, 2016
(86) PCT No.: PCT/US2016/031934

§ 371 Date: Nov. 8, 2017

Related U.S. Application Data
(60) Provisional application No. 62/159,804, filed on May 11, 2015.

(51) Int. Cl. H01M 10/48; H01M 6/40; H01M 10/052; H01M 10/0585

(52) U.S. Cl. CPC H01M 10/486; H01M 6/40; H01M 10/0562; H01M 10/0585; H01M 10/052

(57) ABSTRACT

A method of fabricating thin film electrochemical devices may comprise: depositing on a substrate a stack of layers comprising a CCC, a cathode, an electrolyte, an anode and an ACC; laser die patterning the stack to form die patterned stacks; laser patterning the die patterned stacks to reveal contact areas of at least one of the CCC layer and the ACC layer for each of the die patterned stacks, the laser patterning the die patterned stacks forming device stacks; depositing a blanket encapsulation layer over the device stacks; laser patterning the blanket encapsulation layer to reveal contact areas of the ACC layer and the CCC layer for each of the device stacks, the laser patterning of the blanket encapsulation layer forming encapsulated device stacks; and identifying hot spots by thermographic analysis of one or more of the device stacks and the encapsulated device stacks.

### CROSS-REFERENCE TO RELATED APPLICATIONS

This application claims the benefit of U.S. Provisional Application No. 62/159,804 filed May 11, 2015, incorporated in its entirety herein.

### FIELD

Embodiments of the present disclosure relate generally to methods and equipment for manufacturing electrochemical devices, and more specifically, although not exclusively, to thermography methods and equipment for manufacturing thin film batteries.

### BACKGROUND

Thin film batteries (TFB), with their unsurpassed properties, have been projected to dominate the μ-energy application space. As the technology is at the verge of transitioning from R&D to a manufacturing environment, cost effective, in-line characterization of the layers and stacks becomes more critical in achieving cost efficient, high-yielding and high-volume manufacturing of TFBs. There is a need for effective in-line characterization tools and methods for improving the yield of TFBs.

### SUMMARY

According to some embodiments and as described herein, thermographic analysis of electrochemical devices may be integrated into the process flow to detect defects for improvement of device yield. Electrochemical devices include thin film batteries (TFBs), electrochromic devices, etc.

According to some embodiments, a method of fabricating thin film electrochemical devices may comprise: depositing a stack on a substrate, the stack comprising, a cathode current collector layer, a cathode layer, an electrolyte layer, an anode layer and an anode current collector layer; laser die patterning the stack to form a multiplicity of die patterned stacks; laser patterning the multiplicity of die patterned stacks to reveal contact areas of at least one of the cathode current collector layer and the anode current collector layer for each of the multiplicity of die patterned stacks, the laser patterning the multiplicity of die patterned stacks forming a multiplicity of device stacks; depositing a blanket encapsulation layer over the multiplicity of device stacks; laser patterning the blanket encapsulation layer to reveal contact areas of the anode current collector layer and the cathode current collector layer for each of the multiplicity of device stacks, the laser patterning of the blanket encapsulation layer forming a multiplicity of encapsulated device stacks; and identifying hot spots by thermographic analysis of one or more of the multiplicity of device stacks and the multiplicity of encapsulated device stacks.

According to some embodiments, a method of fabricating thin film electrochemical devices may comprise: depositing a stack on a substrate, the stack comprising, a cathode current collector layer, a cathode layer, an electrolyte layer, an anode layer and an anode current collector layer; patterning the stack to open at least one of a common cathode current collector contact area and a common anode current collector contact area; and identifying hot spots by thermographic analysis of the stack.

According to some embodiments, an apparatus for forming thin film electrochemical devices may comprise: a first system for blanket depositing a stack of a cathode current collector layer, a cathode layer, an electrolyte layer, an anode layer and an anode current collector layer on a substrate; a second system for laser die patterning the stack to form a multiplicity of die patterned stacks; a third system for laser patterning the multiplicity of die patterned stacks to reveal contact areas of at least one of the cathode current collector layer and the anode current collector layer for each of the multiplicity of die patterned stacks, forming a multiplicity of device stacks; a fourth system for depositing a blanket encapsulation layer over the multiplicity of device stacks; a fifth system for laser patterning the blanket encapsulation layer to reveal contact areas of the cathode current collector layer and the anode current collector layer for each of the multiplicity of device stacks, forming a multiplicity of encapsulated device stacks; and a sixth system for thermographic analysis of one or more of the multiplicity of device stacks and the multiplicity of encapsulated device stacks for identifying hot spots, the sixth system comprising: probes for applying a voltage between the cathode current collector layer and the anode current collector layer, and an infrared camera.

### BRIEF DESCRIPTION OF THE DRAWINGS

These and other aspects and features of the present disclosure will become apparent to those ordinarily skilled in the art upon review of the following description of specific embodiments in conjunction with the accompanying figures, wherein:

FIG. 1 is a cross-sectional representation of a first example of a TFB device on a thin substrate for a thin film battery, according to some embodiments;

FIG. 2 is a cross-sectional representation of a second example of a TFB device on a thin substrate for a thin film battery, according to some embodiments;

FIGS. 3A & 3B show a schematic representation, in top plan view and cross-sectional (section X-X) view respectively, of stack fabrication with a global (common) CCC for a vertical stack TFB, according to some embodiments;

FIG. 4 shows a schematic representation of die patterning of the stack of FIG. 3B, according to some embodiments;

FIG. 5 shows a schematic representation of CCC reveal for the stacks of FIG. 4, according to some embodiments;

FIG. 6 shows a schematic representation of blanket deposition of a thin film encapsulation layer over the stacks of FIG. 5, according to some embodiments;

FIG. 7 shows a schematic representation of CCC/ACC reveal for all stacks in FIG. 6 by laser patterning of the blanket encapsulation layer, according to some embodiments;

FIG. 8 is a process flow for the TFB of FIGS. 3A, 3B, 4, 5, 6 & 7 showing places in the flow where thermography may be used, according to some embodiments;

FIGS. 9A & 9B are schematic representations of a thermography tool on an in-line TFB fabrication line, according to some embodiments;

FIGS. 10A-10D show thermographic data for a TFB, according to some embodiments; and

FIG. 11 is a schematic representation of an in-line TFB fabrication system, according to some embodiments.

### DETAILED DESCRIPTION

Embodiments of the present disclosure will now be described in detail with reference to the drawings, which are provided as illustrative examples of the disclosure so as to enable those skilled in the art to practice the disclosure. The drawings provided herein include representations of devices and device process flows which are not drawn to scale. Notably, the figures and examples below are not meant to limit the scope of the present disclosure to a single embodiment, but other embodiments are possible by way of interchange of some or all of the described or illustrated elements. Moreover, where certain elements of the present disclosure can be partially or fully implemented using known components, only those portions of such known components that are necessary for an understanding of the present disclosure will be described, and detailed descriptions of other portions of such known components will be omitted so as not to obscure the disclosure. In the present disclosure, an embodiment showing a singular component should not be considered limiting; rather, the disclosure is intended to encompass other embodiments including a plurality of the same component, and vice-versa, unless explicitly stated otherwise herein. Moreover, it is not intended for any term in the present disclosure to be ascribed an uncommon or special meaning unless explicitly set forth as such. Further, the present disclosure encompasses present and future known equivalents to the known components referred to herein by way of illustration.

Thin film batteries (TFB), with their unsurpassed properties, have been projected to dominate the μ-energy application space. As the technology is at the verge of transitioning from R&D to manufacturing environment, cost effective, in-line characterization of the layers and stacks becomes more critical in achieving cost efficient, high-yielding and high-volume manufacturing of TFBs. Thermography tools and process flows using the same may in embodiments provide in-line characterization for improving the yield of TFBs and other electrochemical devices. Herein the term thin film is used to refer to films with thicknesses less than or equal to 30 microns. A thin film solid state battery herein refers to a battery in which all component films are thin films.

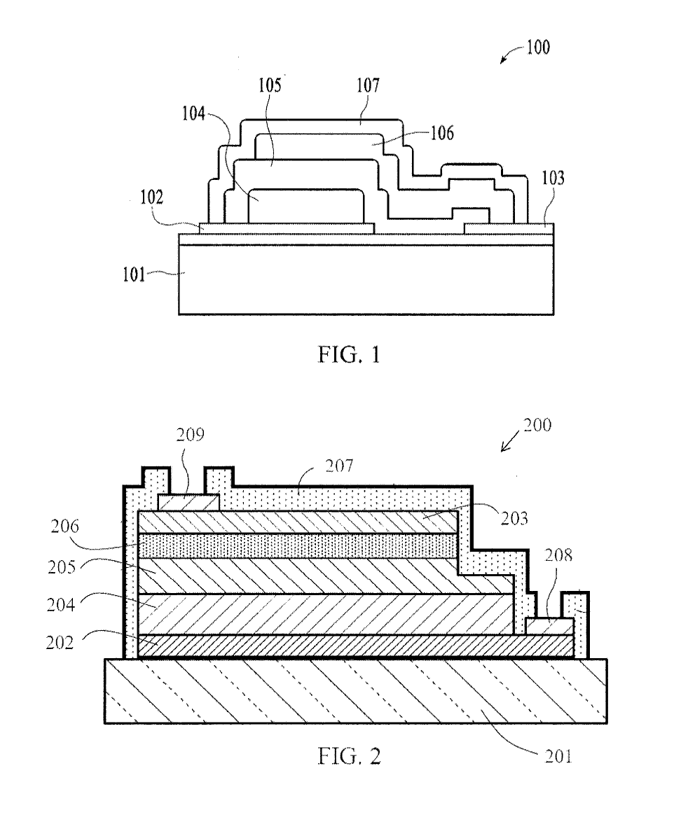

A description of TFB devices that may advantageously utilize embodiments of the present disclosure is provided below with reference to FIGS. 1 & 2.

FIG. 1 shows a first TFB device structure 100 with cathode current collector 102 and anode current collector 103 formed on a substrate 101, followed by cathode 104, electrolyte 105 and anode 106; although the device may be fabricated with the cathode, electrolyte and anode in reverse order. Furthermore, the cathode current collector (CCC) and anode current collector (ACC) may be deposited separately. For example, the CCC may be deposited before the cathode and the ACC may be deposited after the electrolyte. The device may be covered by an encapsulation layer 107 to protect the environmentally sensitive layers from oxidizing agents.

According to embodiments the TFB device of FIG. 1 may be fabricated by the following process: provide substrate; deposit patterned CCC; deposit patterned ACC; deposit patterned cathode; cathode anneal; deposit patterned electrolyte; deposit patterned anode; and deposit patterned encapsulation layer. Shadow masks may be used for the deposition of patterned layers. In embodiments the cathode is LiCoO₂ and the anneal is at a temperature of up to 850° C.

FIG. 2 shows a second example TFB device structure 200 comprising a substrate 201, a current collector layer 202 (e.g. Ti/Au), a cathode layer 204 (e.g. LiCoO₂), an electrolyte layer 205 (e.g. LiPON), an anode layer 206 (e.g. Li, Si), an ACC layer 203 (e.g. Ti/Au), bonding pads (Al, for example) 208 and 209 for ACC and CCC, respectively, and a blanket encapsulation layer 207 (polymer, silicon nitride, for example).

According to embodiments the TFB device of FIG. 2 may be fabricated by the following process: provide substrate; blanket deposit CCC, cathode, electrolyte, anode, and ACC to form a stack; cathode anneal; laser pattern stack; deposit patterned contact pads; deposit encapsulation layer; laser pattern encapsulation layer. In embodiments the cathode is LiCoO₂ and the anneal is at a temperature of up to 850° C.

The specific TFB device structures and methods of fabrication provided above with reference to FIGS. 1 & 2 are merely examples and it is expected that a wide variety of different TFB and other electrochemical device structures and fabrication methods may benefit from thermography as described herein.

Furthermore, a wide range of materials may be utilized for the different TFB device layers. For example, a cathode layer may be a LiCoO₂ layer (deposited by e.g. RF sputtering, pulsed DC sputtering, etc.), an anode layer may be a Li metal layer (deposited by e.g. evaporation, sputtering, etc.), and an electrolyte layer may be a LiPON layer (deposited by e.g. RF sputtering, etc.). However, it is expected that the present disclosure may be applied to a wider range of TFBs comprising different materials. Furthermore, deposition techniques for these layers may be any deposition technique that is capable of providing the desired composition, phase and crystallinity, and may include deposition techniques such as PVD, PECVD, reactive sputtering, non-reactive sputtering, RF sputtering, multi-frequency sputtering, electron and ion beam evaporation, thermal evaporation, CVD, ALD, etc.; the deposition method can also be non-vacuum based, such as plasma spray, spray pyrolysis, slot die coating, screen printing, etc. For a PVD sputter deposition process, the process may be AC, DC, pulsed DC, RF, HF (e.g., microwave), etc., or combinations thereof. Examples of materials for the different component layers of a TFB may include one or more of the following. The ACC and CCC may be one or more of Ag, Al, Au, Ca, Cu, Co, Sn, Pd, Zn and Pt which may be alloyed and/or present in multiple layers of different materials and/or include an adhesion layer of a one or more of Ti, Ni, Co, refractory metals and super alloys, etc. The cathode may be LiCoO₂, V₂O₅, LiMnO₂, Li₅FeO₄, NMC (NiMnCo oxide), NCA (NiCoAl oxide), LMO (LiₓMnO₂), LFP (LiₓFePO₄), LiMn spinel, etc. The solid electrolyte may be a lithium-conducting electrolyte material including materials such as UPON, LiI/Al₂O₃ mixtures, LLZO (LiLaZr oxide), LiSiCON, Ta₂O₅, etc. The anode may be Li, Si, silicon-lithium alloys, lithium silicon sulfide, Al, Sn, C, etc.

The anode/negative electrode layer may be pure lithium metal or may be a Li alloy, where the Li is alloyed with a metal such as tin or a semiconductor such as silicon, for example. The Li layer may be about 3 μm thick (as appropriate for the cathode and capacity balancing) and the encapsulation layer may be 3 μm or thicker. The encapsulation layer may be a multilayer of polymer/parylene and metal and/or dielectric, and may be formed by repeated deposition and patterning, as needed. Note that, between the formation of the Li layer and the encapsulation layer, in some embodiments the part is kept in an inert or very low humidity environment, such as argon gas or in a dry-room; however, after blanket encapsulation layer deposition the need for an inert environment will be relaxed. The ACC may be used to protect the Li layer allowing laser ablation outside of vacuum and the need for an inert environment may be relaxed.

Furthermore, the metal current collectors, both on the cathode and anode side, may need to function as protective barriers to the shuttling lithium ions. In addition, the anode current collector may need to function as a barrier to oxidants (e.g. H₂O, O₂, N₂, etc.) from the ambient. Therefore, the current collector metals may be chosen to have minimal reaction or miscibility in contact with lithium in “both directions”—i.e., the Li moving into the metallic current collector to form a solid solution and vice versa. In addition, the metallic current collector may be selected for its low reactivity and diffusivity to the oxidants from the ambient. Some potential candidates for acting as protective barriers to shuttling lithium ions may be Cu, Ag, Al, Au, Ca, Co, Sn, Pd, Zn and Pt. With some materials, the thermal budget may need to be managed to ensure there is no reaction/diffusion between the metallic layers. If a single metal element is incapable of meeting both needs, then alloys may be considered. Also, if a single layer is incapable of meeting both needs, then dual (or multiple) layers may be used. Furthermore, in addition an adhesion layer may be used in combination with a layer of one of the aforementioned refractory and non-oxidizing layers—for example, a Ti adhesion layer in combination with Au. The current collectors may be deposited by (pulsed) DC sputtering of metal targets (approximately 300 nm) to form the layers (e.g., metals such as Cu, Ag, Pd, Pt and Au, metal alloys, metalloids or carbon black). Furthermore, there are other options for forming the protective barriers to the shuttling lithium ions, such as dielectric layers, etc.

In embodiments one or more of the component device layers such as anode, cathode, ACC, CCC, electrolyte and encapsulation layer may comprise multiple layers. For example, a CCC layer may comprise a layer of Ti and a layer of Pt or a layer of alumina, a layer of Ti and a layer of Pt, an encapsulation layer may comprise multiple layers as described above, etc.

Having considered the TFB structures of FIGS. 1 & 2, including material choices for the different layers and some aspects of the fabrication processes, some of the more common causes of battery yield losses are considered.

One of the key detriments to the yield of electrochemical devices is the internal electrical short, especially through the electrolyte layer, which can be caused by various defects (both mechanical and in-film defects). Such defects can form at any steps along the fabrication flow. However, these defects are generally more critical when they are formed in the LiCoO₂ (cathode) and LiPON (electrolyte) deposition steps—this can be manifested for example by incomplete, non-conformal coating of the LiPON layer around such defects in the LiCoO₂ layer, leading to pinholes and subsequent internal electrical shorting in finished devices. Some pinholes may not be percolated at the end of the fabrication processes but can develop into fully percolated pinholes during device operation either from breakdown potential limitation or by mechanical breathing of the device structure from cycling and handling.

Outside of pinholes and misalignments of the deposited layers that can cause an internal electrical short within the device stack, it is also possible for a post deposition process, such as a scribing step, by mechanical means, or by laser, which can generate defects such as: smears, burrs or redeposition that can create shunts in the device. Thermography and lock-in thermography can locate these faults. In a high volume manufacturing environment, a simple and fast characterization of such defects is very beneficial in identifying the root causes of said defects and eliminating them, potentially enabling a high yielding manufacturing process flow. Thermography may be the metrology for such a purpose. Thermography measures the surface temperature, including the temperature changes and the extent of localization and the distribution of any “hot spots”, when external stimuli are applied to the device. (A “hot spot” may be due to an internal electrical leakage current leading to resistive heating and the spot becoming “hotter in temperature” than the location where no internal leakages exist, although a “hot spot” may not necessarily be due only to internal electrical leakage. For example, if there is a spot where the resistance is significantly higher than in surrounding material, when current passes through the material, more resistive heating is generated in the “spot” and therefore a higher T is observed at the location of the “spot”.) For TFBs, this external stimulus would be current and/or voltage applied across the device/location electrodes (generally between ACC and CCC), which induces, if electrical pinholes are present, current flow/leak, followed by local resistive heating and a corresponding measurable temperature change—these localized variations in temperature are what would be captured by thermography. The applied stimulus may be a pulsed/cyclic voltage signal, for example, which is interlocked with the thermographic measuring system. A thermographic image of the device surface is captured by heat sensors showing the position of such defects. The locational of these defects is provided for root cause analysis and for the prediction of stack/device integrity for device yield. Such information can be fed forward to predict known-good-dies and known-good-die-regions vs. known-bad-dies and known-bad-die-regions to minimize performing unnecessary processing and device characterization. This is particularly important for the “maskless integration” (not using physical shadow masks for patterning) as the depositions are typically blanket, followed by ex situ device patterning steps. The location of defects acquired using thermography may be provided to a marking/scribing tool so that known defects and surrounding portions of the device can easily be marked—by ink or laser scribing, for example—and eliminated from further processing and characterization. In some embodiments in the case of laser marking this may be done by a direct laser patterning tool, but at lower power than used for patterning since only a surface scribing sufficient for visual effect may be needed and not a full stack ablation. In some embodiments the laser patterning tool may be used for both marking and patterning of devices. Marking may in embodiments be open or closed circles around the defects. (In embodiments the marking may be in layers 106 in FIGS. 1 and 203 in FIG. 2, for example.) In some embodiments, defective devices/device areas may be electrically isolated by scribing through the layers completely around the defect so as to separate the defect from the rest of the device. This approach may be attractive to use for larger area devices and can be a technique applied for yield improvement. The extent to which further processing can be eliminated depends on the point in the process flow at which defects are identified using the thermography and also on the approach. For example, independent of good or bad regions, the whole substrate area can be processed through the full flow, and only upon die singulation (cutting substrate to separate individual devices), are the dies from the bad regions thrown away. In other embodiments, after identification of a bad device/region, processing may be limited for that bad device/region where practical—for example, laser patterning—for ACC and CCC contact area reveal, for example—may be skipped for defective devices/areas identified with the thermography, although blanket depositions of material such as an encapsulation layer would be unaffected; the defective devices/areas would be separated and discarded at a suitable point in the process flow, for example after die singulation. Potential benefits of the latter may be (1) less time at those patterning steps for higher throughput, (2) lower abuse of the laser tool for longer MTBF (mean time between failures) and (3) reduced particle generation for better encapsulation. Common to these different approaches is the identification of defects by thermography and the feeding forward of the information of bad or good regions for use in all subsequent steps—whether used to limit processing, and/or discard defective devices after singulation. All these different approaches are expected to contribute to lower CoO (Cost of Ownership) and higher yield.

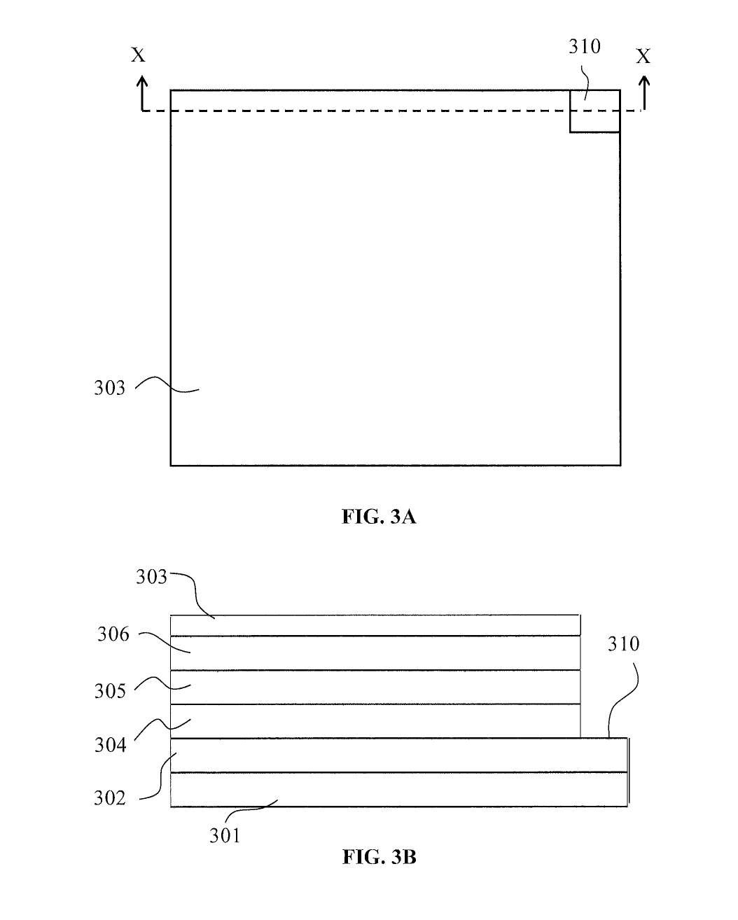

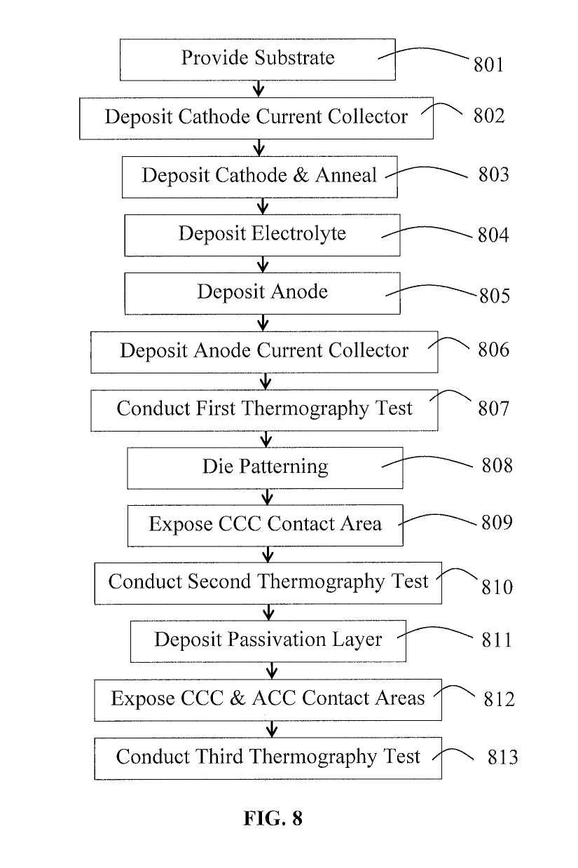

FIGS. 3A, 3B, 4, 5, 6 & 7 illustrate the fabrication of vertical stack thin film batteries according to some embodiments. FIG. 8 provides a process flow, according to some embodiments, that may be used to form the vertical stack TFBs of FIGS. 3A, 3B, 4, 5, 6 & 7. The points in a typical vertical stack TFB process flow at which thermography will be most effective is, in embodiments, after the stack has formed the basic cell structure with capability of applying I-V signals/stimuli across two opposite current collectors—e.g., after substrate/CCC/Cathode/Electrolyte/anode/ACC stacks are formed and applying the stimuli at the CCC and ACC.

FIGS. 3A and 3B show a substrate 301, a current collector layer 302, a cathode layer 304, an electrolyte layer 305, an anode layer 306, an ACC layer 603 and an exposed global (common) CCC contact area 310. This structure may be formed following the first part of the process flow of FIG. 8: provide substrate (801); deposit CCC on substrate (802); deposit cathode on CCC and anneal (803); deposit electrolyte on annealed cathode (804); deposit anode on electrolyte (805); and deposit ACC on anode (806). The first place to perform the thermography test would be after the stack fabrication is completed, indicated as “807” in the process flow of FIG. 8. At this point, one would have to find a contact path to the bottom electrode, achievable by simple edge patterning to expose a portion of the bottom contact 310, using a generic recipe for CCC exposure, for example. Once a defect map is obtained, then defect areas can be eliminated from subsequent device patterning, testing and binning (to varying extents based on number and severity of hot spots) by marking those regions with a laser and/or other methods. In this regard, one can integrate the hardware of the thermographic imager into a laser patterning tool, to integrate the whole functionality and objectives—pre-electrical battery-test binning of the substrates and devices. Note that formation of a global CCC contact 310 such as shown in FIGS. 3A & 3B may be by a laser ablation process, for example, to reveal the CCC contact by removal of deposited layers from a corner or other convenient area of the stack; in other embodiments, masks can be used to define the extent of the layers of the stack, and the layers above the CCC would be slightly smaller to create an uncovered CCC corner (or any other contact region).

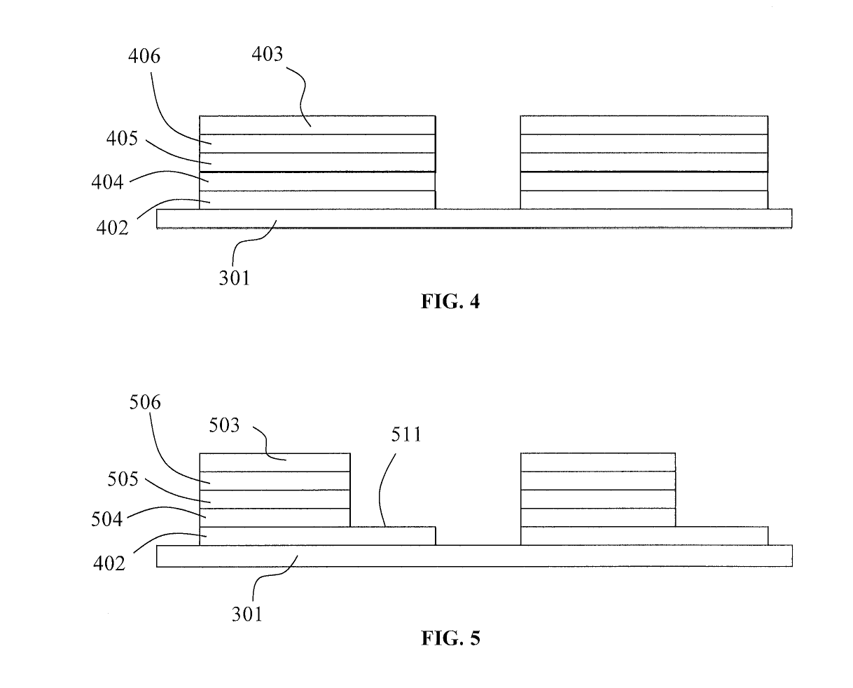

With reference to FIGS. 4 & 8, a structure is formed which comprises a substrate 301 on which two stacks have been formed by die patterning (808), each of the stacks comprising: a current collector layer 402, a cathode layer 404, an electrolyte layer 405, an anode layer 406, and an ACC layer 403. FIG. 5 shows the structure of FIG. 4 subject to further processing (809) to expose CCC contact areas 511; a majority of the stack layers of FIG. 4 were processed to remove a portion of the layer in order to expose the contact areas 511, consequently the stack in FIG. 5 comprises the following layers with a portion removed: cathode layer 504, electrolyte layer 505, anode layer 506, and ACC layer 503. The second place that can use the thermography test is after the full die pattering and CCC exposures are done, indicated as “810” in FIG. 8. In this case, the stimuli contacts are made to the top and bottom current collectors of each die (with a probe card, for example). Again, the thermographic map can provide the initial binning between known-good vs. known-bad dies. Again, this can be a metrology on board a laser scribing tool.

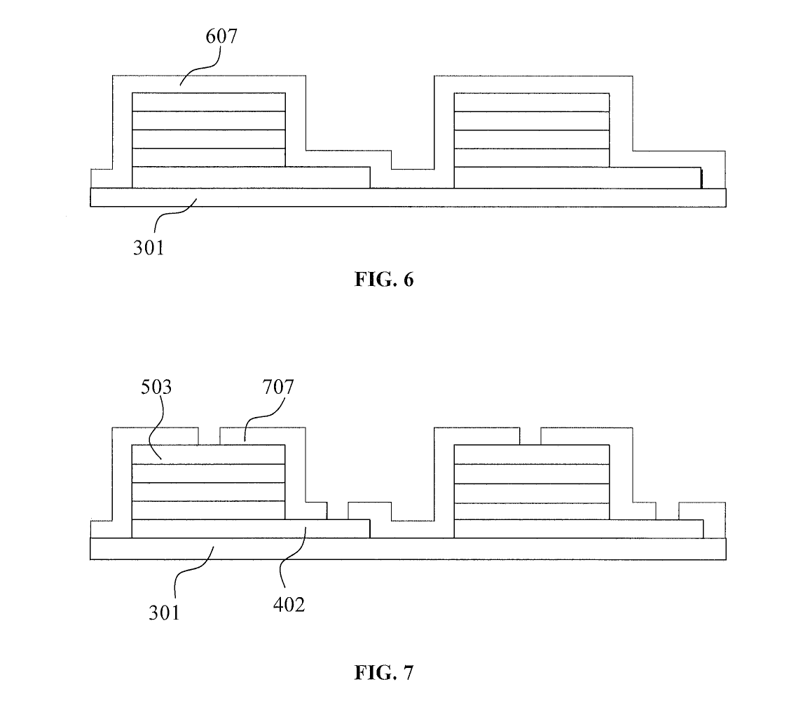

With reference to FIGS. 6 & 8, a structure is formed which comprises a passivation layer 607 (also referred to as an encapsulation layer) over the structure of FIG. 5—the passivation layer deposition 811 may be a PVD or CVD deposition of a nitride or polymer, for example. With reference to FIGS. 7 & 8, the passivation layers of the TFBs are patterned to form passivation layers 707 which comprise openings in the layer to allow electrical contact to the ACC 503 and CCC 402—the exposure of the ACC and CCC contact areas 812 may be a patterning and etching process, for example. A third place where the thermography technique can be applied is after CCC/ACC exposure of the completed TFB device, the TFB device including the passivation/encapsulation layers at this point in the process flow, is indicated as “813” in FIG. 8. The same advantages for yield apply at this point as described above.

As discussed previously, some pinholes may not be percolated at the end of the TFB fabrication process, but can develop into fully percolated pinholes during operation of the battery either from voltage breakdown or mechanical breathing of the structure from cycling and handling. To test for such incipient defects, one may apply voltages (or perhaps current, but with additional limitations on voltage and device operation) consistent with the battery operation and cycle the battery to induce early failure and potentially eliminate the need for subsequent test/cycling based cell integrity testing (currently the Li-Ion battery industry does extended shelf life testing to eliminate devices with defects that result in early failure). This process may be integrated into the fabrication methods described above. For example, a voltage signal may be applied between ACC and CCC to cycle the TFB devices/structures so as to more fully develop defects prior to thermographic analysis.

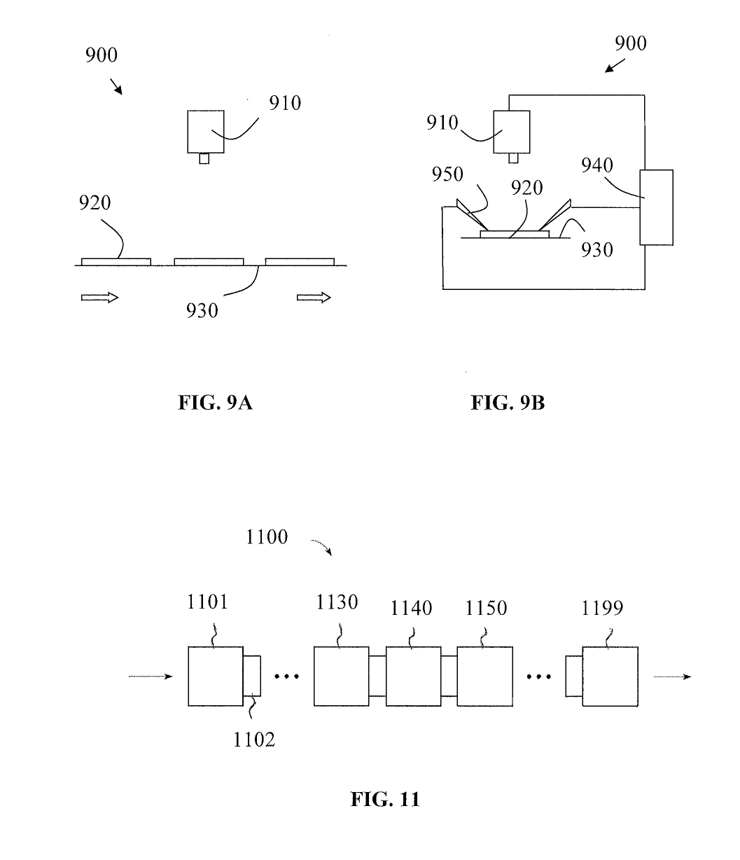

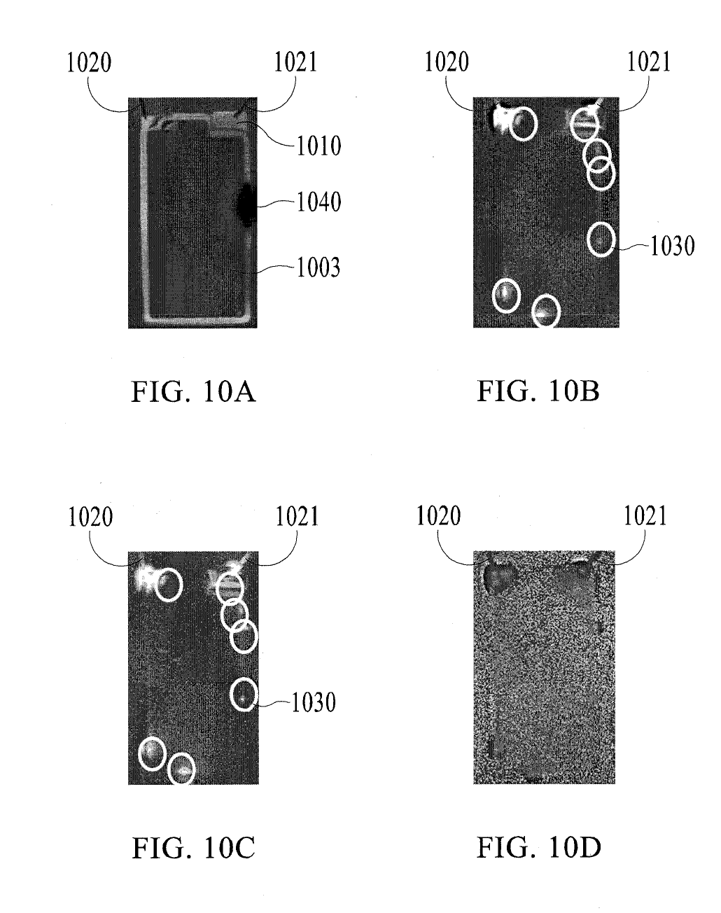

FIGS. 9A & 9B show schematic representations of a thermography tool 900 on an in-line TFB fabrication line, according to some embodiments. Tool 900 includes an infrared camera (with IR detector array) 910 set up to image substrates 920 moving on a conveyor 930 in an in-line processing system. The camera 910 and electrical probes 950 are connected to a computer/controller 940. The computer/controller 940 controls the electrical stimuli applied to structures on the substrate 920 and collects thermal images as the stimuli are applied. The computer/controller 940 processes the data to generate images such as those shown in FIG. 10, discussed in more detail below. The spectral range of the IR detectors ranges from 3 microns to 14 microns in wavelength, and up to 250 Hz or 390 Hz (depending on the sensor selected) for a full image (higher for partial image). The detectors can have resolutions of 640×512 pixels or 1280×1024 pixels (depending on sensor selected), for example. In embodiments, a pixel resolution of up to 2 microns and a thermal resolution of up to 0.02K may be available. The optics of the camera can be selected to view a full device/array of devices or zoom in to view defects in higher resolution. As an example, assuming a field of view of 5 cm, a 10 um/pixel resolution (using the 640×512 sensor) can be achieved, although, by either using a high definition sensor (1280×1024 pixels) or zooming in, even higher resolution can be attained.

The thermography tool for defect detection in a vertical stack TFB may be operated in embodiments as follows. The signal, current and/or voltage, is applied consistent with the stability window of the battery operation. The voltage applied does not exceed the material-dependent electrical/electrochemical stability windows of the active components (cathode, anode and electrolyte) and the battery operating voltages limitation. For LiCoO₂, this would be a 3.0V to 4.2V operating window. The applied polarity of the voltage is controlled as well: on the manufacturing line, the applied polarity may be set to induce “charging of the cell” as the cell is fabricated in a “discharged” state when a LiCoO₂ cathode is used—use of the incorrect (opposite) polarity can potentially damage the cell. Furthermore, the current level is also limited to ensure that it is just sufficient to see the thermographic response but not high enough to affect the cell's depth of discharge. This appropriate current level for testing will depend on the location of the test in the process flow—first thermography test 807 or second thermography test 810 in the process flow of FIG. 8. The limit may be much smaller at the second thermography test 810 as it deals with individual die. The stimuli can be DC or in embodiments some form of pulsed signal which may have the advantage of minimizing the impact on the battery structure/yield. In addition, the testing with the polarity in the opposite or “discharging of the cell” direction may be beneficial in determining purely electrical leakage locations as long as the applied voltage/current is not beyond the stability window and operating voltage of the cells and materials. This is so because the as-fabricated cells are in fully discharged state (or near to it). Applying the polarity in this manner will not incur local heating from the battery's natural electrochemical reactions but only from electrical leakage if such is present. Such signals can be coordinated with the thermal signal monitoring to gauge, for example, the depth of a thermal “hotspot” in the vertical stack. By using lock-in algorithms, thermography signals would be enhanced, along with improved signal-to-noise ratio, as well as providing improved spatial resolution when compared to static thermography techniques. In some embodiments, a “hot spot” may be identified by a temperature differential of at least 3 to 5 times the average local temperature variation (from the median temperature) for the stack/device.

An example of defect maps generated for a TFB is provided in FIGS. 10A-10D. The images are of a TFB which has completed processing through deposition of ACC (806) in FIG. 8—see structure of FIGS. 3A & 3B. FIG. 10A is an IR image showing a “hot spot” 1040 at the edge of the device/die—seen as a dark patch in the figure; the probes 1020 and 1021 used to make electrical contact with the device are seen in the top left and right corners, making contact to ACC 1003 and global (common) CCC contact 1010. FIGS. 10B-10D are lock-in thermal images showing high resolution defect imaging of the same device imaged in FIG. 10A—various “hot spots” 1030 are evident in the images and for ease of recognition are circled; note that most defects are located at the edges of the device/die. FIG. 10B is a single phase lock in thermal image (the specific phase is selectable and will typically be used to identify defects at different depths in the device), FIG. 10C is a lock-in amplitude image showing all defects identified, and FIG. 10D is a lock-in thermal phase image which may be used to help identify specific phases associated with the different defects shown in FIG. 10C.

FIG. 11 shows a representation of an in-line fabrication system 1100 with multiple in-line tools 1101 through 1199, including tools 1130, 1140, 1150, according to some embodiments. In-line tools may include tools for depositing and patterning all the layers of a TFB, as well as thermography tools, such as described herein, for testing devices at various points in the flow, such as outlined in FIG. 8. Furthermore, the in-line tools may include pre- and post-conditioning chambers. For example, tool 1101 may be a pump down chamber for establishing a vacuum prior to the substrate moving through a vacuum airlock 1102 into a deposition tool. Some or all of the in-line tools may be vacuum tools separated by vacuum airlocks. Note that the order of process tools and specific process tools in the process line will be determined by the particular TFB fabrication method being used, for example, as specified in the process flows described above. Furthermore, substrates may be moved through the in-line fabrication system oriented either horizontally or vertically. Yet furthermore, thermography tools may be configured for substrates to be stationary during testing, or moving.

Although the examples of tools provided herein are for an in-line processing system, in embodiments thermography tools may be incorporated in cluster tools or as a stand-alone tool.

According to some embodiments, an apparatus for forming thin film electrochemical devices may comprise: a first system for blanket depositing a stack of a cathode current collector layer, a cathode layer, an electrolyte layer, an anode layer and an anode current collector layer on a substrate; a second system for laser die patterning the stack to form a multiplicity of die patterned stacks; a third system for laser patterning the multiplicity of die patterned stacks to reveal contact areas of at least one of the cathode current collector layer and the anode current collector layer for each of the multiplicity of die patterned stacks, forming a multiplicity of device stacks; a fourth system for depositing a blanket encapsulation layer over the multiplicity of device stacks; a fifth system for laser patterning the blanket encapsulation layer to reveal contact areas of the cathode current collector layer and the anode current collector layer for each of the multiplicity of device stacks, forming a multiplicity of encapsulated device stacks; and a sixth system for thermographic analysis of one or more of the multiplicity of device stacks and the multiplicity of encapsulated device stacks for identifying hot spots, the sixth system comprising: probes for applying a voltage between the cathode current collector layer and the anode current collector layer, and an infrared camera. Furthermore, a plurality of sixth systems may be used for thermographic analysis, each of the plurality of sixth systems being dedicated to thermographic analysis of the electrochemical device at different particular stages of fabrication. Furthermore, the plurality of sixth systems may be positioned in-line. Furthermore, the apparatus may further comprise a laser patterning system for marking the hot spots on the thin film electrochemical devices. Furthermore, the apparatus may further comprise a seventh system for laser patterning the stack to form a patterned stack with a common current collector contact area, and the sixth system may be configured for thermographic analysis of the patterned stack with a common current collector contact area. Furthermore, the first system may form a patterned stack by depositing the cathode layer, the electrolyte layer, the anode layer and one or more of the anode current collector layer and the anode current collector layer through shadow masks to form at least one of an open common cathode current collector contact area and an open common anode current collector contact area, and wherein the sixth system is configured for thermographic analysis of the device stack with at least one of an open common cathode current collector contact area and an open common anode current collector contact area.

Although embodiments of the present disclosure have been described herein with reference to specific examples of TFB devices, process flows and manufacturing apparatus, the teaching and principles of the present disclosure may be applied to a wider range of TFB devices, process flows and manufacturing apparatus. For example, devices, process flows and manufacturing apparatus are envisaged for TFB stacks which are inverted from those described previously herein—the inverted stacks having ACC and anode on the substrate, followed by solid state electrolyte, cathode, CCC and encapsulation layer. For example, devices, process flows and manufacturing apparatus are envisaged for TFB stacks with coplanar current collectors, such as shown in FIG. 1. Furthermore, those of ordinary skill in the art would appreciate how to apply the teaching and principles of the present disclosure to generate a wide range of devices, process flows and manufacturing apparatus.

Although embodiments of the present disclosure have been described herein with reference to TFBs, the teaching and principles of the present disclosure may also be applied to improved devices, process flows and manufacturing apparatus for fabricating other electrochemical devices, including electrochromic devices. Those of ordinary skill in the art would appreciate how to apply the teaching and principles of the present disclosure to generate devices, process flows and manufacturing apparatus which are specific to other electrochemical devices.

Although embodiments of the present disclosure have been particularly described with reference to certain embodiments thereof, it should be readily apparent to those of ordinary skill in the art that changes and modifications in the form and details may be made without departing from the spirit and scope of the disclosure.

What is claimed is:

1. A method of fabricating thin film electrochemical devices, comprising:
depositing a stack on a substrate, said stack comprising, a cathode current collector layer, a cathode layer, an electrolyte layer, an anode layer and an anode current collector layer;
laser die patterning said stack to form a multiplicity of die patterned stacks;
laser patterning said multiplicity of die patterned stacks to reveal contact areas of at least one of said cathode current collector layer and said anode current collector layer for each of said multiplicity of die patterned stacks, said laser patterning said multiplicity of die patterned stacks forming a multiplicity of device stacks;
depositing a blanket encapsulation layer over said multiplicity of device stacks;
laser patterning said blanket encapsulation layer to reveal contact areas of said anode current collector layer and said cathode current collector layer for each of said multiplicity of device stacks, said laser patterning of said blanket encapsulation layer forming a multiplicity of encapsulated device stacks; and
identifying hot spots by thermographic analysis of one or more of said multiplicity of device stacks and said multiplicity of encapsulated device stacks.

2. The method of claim 1, wherein said identifying hot spots comprises:
applying a voltage between one or more cathode current collector layers and said corresponding one or more anode current collector layers,
creating an infrared image of said one or more of said multiplicity of device stacks and said multiplicity of encapsulated device stacks, and
mapping points in said infrared image exceeding a threshold temperature difference compared to a background temperature.

3. The method as in claim 2, wherein said applying a voltage has a polarity in the cell discharging direction.

4. The method of claim 1, wherein said identifying hot spots is by thermographic analysis of one or more of said multiplicity of device stacks.

5. The method of claim 1, wherein said identifying hot spots is by thermographic analysis of one or more of said multiplicity of encapsulated device stacks.

6. The method of claim 1, further comprising, before said identifying hot spots by thermographic analysis, applying a voltage signal consistent with thin film battery operation between said cathode current collector and said anode current collector for cycling said thin film electrochemical device.

7. A method of fabricating thin film electrochemical devices, comprising:
depositing a stack on a substrate, said stack comprising, a cathode current collector layer, a cathode layer, an electrolyte layer, an anode layer and an anode current collector layer;
patterning said stack to open at least one of a common cathode current collector contact area and a common anode current collector contact area; and
identifying hot spots by thermographic analysis of said stack.

8. The method of claim 7, wherein said patterning said stack comprises depositing said cathode layer, said electrolyte layer, said anode layer and one or more of said cathode current collector layer and said anode current collector layer through shadow masks to form at least one of an open common cathode current collector contact area and an open common anode current collector contact area.

9. The method of claim 7, further comprising:
after said patterning, laser die patterning said stack to form a multiplicity of die patterned stacks;
laser patterning said multiplicity of die patterned stacks to reveal contact areas of at least one of said cathode current collector layer and said anode current collector layer for each of said multiplicity of die patterned stacks, said laser patterning said multiplicity of die patterned stacks forming a multiplicity of device stacks;
depositing a blanket encapsulation layer over said multiplicity of device stacks; and
laser patterning said blanket encapsulation layer to reveal contact areas of said anode current collector layer and said cathode current collector layer for each of said multiplicity of device stacks, said laser patterning of said blanket encapsulation layer forming a multiplicity of encapsulated device stacks.

10. The method of claim 9, further comprising identifying hot spots by thermographic analysis of one or more of said multiplicity of device stacks and said multiplicity of encapsulated device stacks.

11. An apparatus for forming thin film electrochemical devices comprising:
a first system for blanket depositing a stack of a cathode current collector layer, a cathode layer, an electrolyte layer, an anode layer and an anode current collector layer on a substrate;
a second system for laser die patterning said stack to form a multiplicity of die patterned stacks;
a third system for laser patterning said multiplicity of die patterned stacks to reveal contact areas of at least one of said cathode current collector layer and said anode current collector layer for each of said multiplicity of die patterned stacks, forming a multiplicity of device stacks;
a fourth system for depositing a blanket encapsulation layer over said multiplicity of device stacks;
a fifth system for laser patterning said blanket encapsulation layer to reveal contact areas of said cathode current collector layer and said anode current collector layer for each of said multiplicity of device stacks, forming a multiplicity of encapsulated device stacks; and
a sixth system for thermographic analysis of one or more of said multiplicity of device stacks and said multiplicity of encapsulated device stacks for identifying hot spots, said sixth system comprising:
probes for applying a voltage between said cathode current collector layer and said anode current collector layer; and
an infrared camera.

12. The apparatus of claim 11, further comprising a seventh system for laser patterning said stack to form a patterned stack with a common current collector contact area.

13. The apparatus of claim 12, wherein said sixth system is configured for thermographic analysis of said patterned stack with a common current collector contact area.

14. The apparatus of claim 11, wherein said first system forms a patterned stack by depositing said cathode layer, said electrolyte layer, said anode layer and one or more of said anode current collector layer and said anode current collector layer through shadow masks to form at least one of an open common cathode current collector contact area and an open common anode current collector contact area.

15. The apparatus of claim 14, wherein said sixth system is configured for thermographic analysis of said device stack with at least one of an open common cathode current collector contact area and an open common anode current collector contact area.
